(19) United States
(12) Patent Application Publication
(10) Pub. No.: US 2021/0144271 A1
(43) Pub. Date: May 13, 2021

(54) SWITCHING OPERATING STATE OF WIRELESS LOCAL AREA NETWORK MODULE

(71) Applicant: Hewlett-Packard Development Company, L.P., Spring, TX (US)

(72) Inventor: Jeongphil KIM, Seongnam-si (KR)

(21) Appl. No.: 17/044,459

(22) PCT Filed: Mar. 25, 2019
(86) PCT No.: PCT/US2019/023868

§ 371 Date: Oct. 1, 2020

(30) Foreign Application Priority Data
Apr. 27, 2018 (KR) 10-2018-0049435

(51) Int. Cl. H04N 1/00

(52) U.S. Cl. CPC H04N 1/00891; H04W 4/80

(57) ABSTRACT

An image forming device is provided. The image forming device includes an image forming job performer, a wireless local area network (WLAN) module, a wireless personal area network (WPAN) module, and a controller. The WPAN module may determine a connection state of an external device using a WPAN, and the controller may receive a request from the external device through the WLAN module that is switched from a disabled state to an enabled state in accordance with the connection state of the external device using the WPAN, to control the image forming job performer.

### BACKGROUND

An image forming device may perform various types of wireless communication with an external device. Various wireless communication methods such as near field communication (NFC), Bluetooth, and wireless fidelity (Wi-Fi) direct (WFD) have different ranges, data rates, and power consumption amounts.

### BRIEF DESCRIPTION OF DRAWINGS

The above and other aspects, features, and advantages of certain examples of the disclosure will be more apparent from the following description taken in conjunction with the accompanying drawings, in which:

FIG. 1 is a view showing a mode of performing different types of wireless communication between an image forming device and an external device, according to an example;

FIG. 2 is a flowchart for explaining a method of controlling an image forming device, according to an example;

FIGS. 3 to 7 are block diagrams for explaining a configuration and an operation of an image forming device, according to various examples; and

FIG. 8 is a block diagram for explaining a configuration of an image forming device, according to another example.

Throughout the drawings, it should be noted that like reference numbers are used to depict the same or similar elements, features, parts, components, and structures and thus, a repeated description thereof may be omitted.

### DETAILED DESCRIPTION

Hereinafter, various examples will now be described with reference to the accompanying drawings. In this regard, the examples may have different forms and should not be construed as being limited to the descriptions set forth herein. In order to further clearly describe features of the examples, descriptions of other features that are well known to one of ordinary skill in the art are omitted here.

Throughout the specification, when an element is referred to as being “connected” or “coupled” to another element, it can be directly connected or coupled to the other element, or can be connected or coupled to the other element with intervening elements interposed therebetween. In addition, the terms “comprises” and/or “comprising” or “includes” and/or “including” when used in this specification, specify the presence of stated elements, but do not preclude the presence or addition of one or more other elements.

Expressions such as “at least one of,” when preceding a list of elements, modify the entire list of elements and do not modify the individual elements of the list.

In the specification, an “image forming job” may denote any one of various jobs (for example, printing, copying, scanning, and faxing) related to an image, such as forming of an image or generating/storing/transmitting of an image file, and a “job” may denote not only an image forming job, but may also denote a series of processes required to perform the image forming job.

Expressions such as “at least one of,” when preceding a list of elements, modify the entire list of elements and do not modify the individual elements of the list.

Also, an “image forming device” may denote any device or apparatus capable of performing an image forming job, such as a printer, a scanner, a copier, a fax machine, a multi-function printer (MFP), a display apparatus, or the like.

FIG. 1 is a view showing a mode of performing different types of wireless communication between an image forming device and an external device, according to an example.

Referring to FIG. 1, an image forming device 100 and an external device 200 may be connected to each other according to any of different types of wireless communication. For example, the image forming device 100 and the external device 200 may perform wireless communication using a wireless personal area network (WPAN) such as near field communication (NFC) or Bluetooth, or wireless communication using a wireless local area network (WLAN) such as wireless fidelity (Wi-Fi) direct (WFD).

The image forming device 100 may perform wireless communication with the external device 200 using different types of wireless communication networks. To perform the different types of wireless communication, the image forming device 100 may include a module for each type of wireless communication. However, continuously powering all communication modules for performing respective wireless communication methods in an enabled state may result in unnecessary power consumption.

In order to minimize the unnecessary power consumption, a method of preventing unnecessary power consumption in the image forming device 100 by keeping a default state of a WLAN module in a disabled state may be considered. In this regard, switching of an operating state of the WLAN module will be described below.

FIG. 2 is a flowchart for explaining a method of controlling an image forming device according to an example.

Referring to FIG. 2, the image forming device 100 may determine a connection state of the external device 200 using a WPAN in operation 2010. If there is no connection of the external device using the WPAN, the WLAN module may be disabled in the image forming device 100.

In operation 2020, the image forming device 100 may switch the WLAN module in the disabled state to an enabled state according to the connection state with the external device 200 using the WPAN. For example, when the external device 200 tries to connect to the image forming device 100 using the WPAN, or when the connection is completed, the image forming device 100 may switch the WLAN module into an enabled state. For this purpose, the WPAN module may determine the connection state of the external device 200 using the WPAN. The WPAN module may be a Bluetooth module or an NFC module, but is not limited thereto. The WLAN module may detect the connection state of the external device 200 using the WPAN to determine an operating state of the WLAN module. The WLAN module may switch its operating state from a disabled state to an enabled state in accordance with the connection state of the external device 200 using the WPAN. If the WLAN module is a WFD module, a WFD function may be turned on.

In operation 2030, the image forming device 100 may receive a request from the external device 200 through the WLAN module.

In operation 2040, the image forming device 100 may perform an image forming job based on a request received from the external device 200.

Hereinafter, various implementations for switching the operating state of the WLAN module will be described.

FIGS. 3 to 7 are block diagrams for explaining a configuration and an operation of an image forming device, according to various example.

Each of FIGS. 3 to 7 shows an example of a manner in which a WLAN module 110 in the image forming device 100 switches an operating state. It is to be understood by those of ordinary skill in the art that other general-purpose components may be further included in addition to the components shown in FIGS. 3 to 7.

Referring to FIGS. 3 to 7, a WPAN module 130 may determine a connection state of the external device 200 using the WPAN. A controller 120 may receive a request from the external device 200 and control an image forming job performer through the WLAN module 110, which is switched from a disabled state to an enabled state in accordance with the connection state of the external device 200 using the WPAN.

In FIGS. 3 and 4, the WLAN module 110 may detect the connection state of the external device 200 using the WPAN from the WPAN module 130 and determine an operating state of the WLAN module 110 based on the detected connection state. The WLAN module 100 may switch its operating state from a disabled state to an enabled state in accordance with the connection state of the external device 200 using the WPAN.

As shown in FIGS. 3 and 4, the WLAN module 110 and the WPAN module 130 may be interconnected. For this purpose, a pin or other connector to be connected to the other module may be allocated in the WLAN module 110 and the WPAN module 130. For example, a connection detection pin indicating a connection state of the external device 200 in the WPAN module 130 and an input/output pin allocated in the WLAN module 110 may be connected to each other.

The WPAN module 130 may change a state value of the connection detection pin, which indicates the connection state of the external device 200, based on the connection state of the external device 200. The WLAN module 110 may determine its operating state based on a state value of the input/output pin connected to the connection detection pin of the WPAN module 130.

The connection detection pin of the WPAN module 130 indicating the connection state of the external device 200 and the input/output pin of the WLAN module 110 may be connected to each other by a connection circuit including a pull-up circuit or a pull-down circuit. As shown in FIG. 3, the pull-up circuit or the pull-down circuit of the connection circuit, which connects the connection detection pin of the WPAN module 130 and the input/output pin of the WLAN module 110 to each other, may be located between the two modules 110 and 130. Furthermore, as shown in FIG. 4, the pull-up circuit or the pull-down circuit of the connection circuit, which connects the connection detection pin of the WPAN module 130 and the input/output pin of the WLAN module 110 to each other, may be located inside any one of the modules. For example, the pull-up circuit or the pull-down circuit may be embedded in the WLAN module 110.

In FIGS. 5 and 6, the controller 120 may detect the connection state of the external device 200 using the WPAN from the WPAN module 130 and determine the connection state of the external device 200. The WLAN module 110 may determine its operating state based on the connection state detected through the controller 120. The WLAN module 110 may determine the operating state according to the connection state detected through the controller 120, or may switch the operating state according to a control command transmitted from the controller 120. The WLAN module 110 may switch its operating state from a disabled state to an enabled state in accordance with the connection state of the external device 200 using the WPAN.

The controller 120 may detect the connection state of the external device 200 using the WPAN from the WPAN module 130 and may determine the connection state of the external device 200 in various ways, such as the examples provided below.

In FIG. 5, the WPAN module 130 may change a state value of the connection detection pin, which indicates the connection state of the external device 200, based on the connection state of the external device 200, and the controller 120 may detect the connection state of the external device 200 based on the state value of an input/output pin connected to the connection detection pin of the WPAN module 130. The connection detection pin of the WPAN module 130 indicating the connection state of the external device 200 and the input/output pin of the controller 120 may be connected to each other by a connection circuit including a pull-up circuit or a pull-down circuit.

As shown in FIG. 5, the pull-up circuit or the pull-down circuit of the connection circuit, which connects the connection detection pin of the WPAN module 130 and the input/output pin of the controller 120 to each other, may be located between the two modules 120 and 130. Furthermore, as shown in FIG. 6, the pull-up circuit or the pull-down circuit of the connection circuit, which connects the connection detection pin of the WPAN module 130 and the input/output pin of the controller 120 to each other, may be located inside any one of the modules. For example, the pull-up circuit or the pull-down circuit may be embedded in the controller 120.

The controller 120 may detect the connection state of the external device 200 using the WPAN from the WPAN module 130 through a communication interface with the WPAN module 130 and determine the connection state of the external device 200. In this case, an existing communication interface connected between the controller 120 and the WPAN module 130 may be utilized.

FIG. 7 is a view for explaining switching of an operating state of a WLAN module when the WLAN module and a WPAN module are packaged into one communication chip, according to an example.

Referring to FIG. 7, a communication chip 160 includes the WLAN module 110, the WPAN module 130, and a chip controller 165. The WLAN module 110 and the WPAN module 130 may be interconnected through the chip controller 165. Therefore, the chip controller 165 may detect the connection state of the external device 200 using the WPAN from the WPAN module 130 and determine the connection state of the external device 200. The WLAN module 110 may determine its operating state based on the connection state detected through the chip controller 165. The WLAN module 110 may determine the operating state itself according to the connection state detected through the chip controller 165, or may switch the operating state according to a control command transmitted from the chip controller 165. The WLAN module 110 may switch its operating state from a disabled state to an enabled state in accordance with the connection state of the external device 200 using the WPAN.

In the various examples described in FIGS. 3 to 7, the WLAN module 110 may switch its operating state from a disabled state to an enabled state in accordance with the connection state of the external device 200 using the WPAN. The WPAN module 130 may perform wireless communication using the WPAN to transmit or receive connection information for wireless communication using the WLAN.

For example, when the WPAN module 130 is a Bluetooth module and the WLAN module 110 is a WFD module, a WFD function of the WLAN module 110 may be switched from a disabled state to an enabled state in accordance with the connection state of the external device 200 using a Bluetooth function, and the WPAN module 130 may perform the Bluetooth function to transmit connection information for the WFD function to the external device 200.

As another example, when the WPAN module 130 is an NFC module and the WLAN module 110 is the WFD module, the WFD function of the WLAN module 110 may be switched from a disabled state to an enabled state in accordance with the connection state of the external device 200 using the NFC function, and the WPAN module 130 may perform the NFC function to transmit or receive connection information for the WFD function to or from the external device 200.

The external device 200 receiving the connection information for the WFD function may perform WFD connection with the image forming device 100 in which the WLAN module 110 is switched to an enabled state. Upon completion of the WFD connection, the image forming device 100 may perform an image forming job based on a request received from the external device 200.

FIG. 8 is a block diagram for explaining a configuration of an image forming device, according to another example.

Referring to FIG. 8, the image forming device 100 may perform an image forming job, such as printing, copying, scanning, or faxing. The image forming device 100 may perform the image forming job according to a user input received through a user interface device 140.

The image forming device 100 may include the WLAN module 110, the controller 120, the WPAN module 130, the user interface device 140, and an image forming job performer 150. It is to be understood by those of ordinary skilled in the art that other general-purpose components may be further included in addition to the components shown in FIG. 8.

The image forming device 100 may communicate with the external device 200 or a network in a wired or wireless manner. The image forming device 100 may include a communication module supporting at least one of various wired and wireless communication methods. For example, the communication module may be in a form of a chipset or may be a sticker or a bar code (e.g., a sticker including an NFC tag) including information required for communication. Wireless communication may include, for example, at least one of Wi-Fi, WFD, Bluetooth, NFC, or the like. Wired communication may include, for example, at least one of universal serial bus (USB), high definition multimedia interface (HDMI), or the like.

In an example, the WLAN module 110 may be a communication module capable of performing the WFD function, and the WPAN module 130 may be a communication module capable of performing the Bluetooth or NFC function.

The controller 120 controls operations of the image forming device 100, and may include at least one processor, such as a central processing unit (CPU). The controller 120 may control other components included in the image forming device 100 such that an operation corresponding to a user input received through the user interface device 140 is performed. The controller 120 may include at least one specialized processor corresponding to each function, or may be a single integrated processor. The controller 120 may access data stored in the memory 140 to use the data, or may store new data in a memory. Also, the controller 120 may execute a program installed in the memory.

The user interface device 140 may include an input unit for receiving, from a user, an input for performing an image forming job, and an output unit for displaying information, such as a result of performing the image forming job or a state of the image forming device 100. For example, the user interface device 140 may be in the form of a touch screen including an operation panel for receiving a user input and a display panel for displaying a screen.

The image forming job performer 150 may perform an image forming job, such as printing, copying, scanning, or faxing. Referring to FIG. 8, the image forming job performer 150 includes a printer 151, a scanner 152, and a facsimile machine 153, but as occasion demands, the image forming job 150 may include some of them or may further include a component for performing another type of image forming job. The image forming job performer 150 may perform the image forming job according to a command for reconfiguring the user input through the user interface device 140 on a main control board. The printer 151 may form an image on a recording medium via any one of various printing methods, such as an electrophotography method, an inkjet method, a thermal transfer method, a thermal method, or the like. The scanner 152 may irradiate light onto paper and receive light reflected from the paper to read an image recorded on the paper. The facsimile machine 153 may share a component for scanning an image with the scanner 152, share a component for printing a received file with the printer 151, transmit a scan file to a destination, or receive a file from the outside.

Any of the above described examples of methods of controlling the image forming device 100 may be implemented in the form of a non-transitory computer-readable recording medium storing instructions or data executable by a computer or a processor. The examples may be written as computer programs and may be implemented in general-use digital computers that execute programs using the computer-readable recording medium. The computer-readable recording medium may include read only memory (ROM), random access memory (RAM), flash memory, CD-ROMs, CD-Rs, CD+Rs, CD-DVD-Rs, DVD-Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, or solid-state disks (SSD), and may be any device capable of storing instructions or software, associated data, data files, and data structures, and providing the instructions or software, associated data, data files, and data structures to a processor or a computer such that the processor or computer may execute the instructions.

While one or more examples have been described with reference to the figures, it will be understood by those of ordinary skill in the art that various changes in form and details may be made therein without departing from the spirit and scope as defined by the following claims.

What is claimed is:

1. An image forming device comprising:
an image forming job performer;
a wireless local area network (WLAN) module;
a wireless personal area network (WPAN) module to determine a connection state of an external device using a WPAN; and
a controller to receive a request from the external device through the WLAN module, which is switched from a disabled state to an enabled state in accordance with the connection state of the external device using the WPAN, to control the image forming job performer.

2. The image forming device of claim 1, wherein the WLAN module detects the connection state of the external device using the WPAN from the WPAN module and determines an operating state of the WLAN module based on the detected connection state.

3. The image forming device of claim 2, wherein the WLAN module switches its operating state from the disabled state to the enabled state in accordance with the connection state of the external device using the WPAN.

4. The image forming device of claim 1, wherein the WPAN module changes a state value of a connection detection pin indicating the connection state of the external device based on the connection state of the external device.

5. The image forming device of claim 4, wherein the WLAN module determines an operating state of the WLAN module based on a state value of an input/output pin connected to the connection detection pin of the WPAN module.

6. The image forming device of claim 5, wherein the connection detection pin indicating the connection state of the external device and the input/output pin are connected to each other by a connection circuit comprising a pull-up circuit or a pull-down circuit.

7. The image forming device of claim 1,
wherein the controller detects the connection state of the external device using the WPAN from the WPAN module, and
wherein the WLAN module determines an operating state of the WLAN module based on the connection state detected by the controller.

8. The image forming device of claim 7, wherein the WLAN module switches its operating state from the disabled state to the enabled state in accordance with the connection state of the external device using the WPAN.

9. The image forming device of claim 1,
wherein the WPAN module changes a state value of a connection detection pin indicating the connection state of the external device, based on the connection state of the external device, and
wherein the controller detects the connection state of the external device based on a state value of an input/output pin connected to the connection detection pin of the WPAN module.

10. The image forming device of claim 9, wherein the connection detection pin of the WPAN module indicating the connection state of the external device and the input/output pin of the controller are connected to each other by a connection circuit comprising a pull-up circuit or a pull-down circuit.

11. The image forming device of claim 1, wherein the controller detects the connection state of the external device using the WPAN from the WPAN module through a communication interface with the WPAN module.

12. The image forming device of claim 1,
wherein the operating state of the WLAN module is switched from the disabled state to the enabled state in accordance with the connection state of the external device using the WPAN, and
wherein the WPAN module performs wireless communication using the WPAN to transmit or receive connection information for wireless communication using the WLAN.

13. The image forming device of claim 12, wherein, when the WPAN module includes a Bluetooth module and the WLAN module includes a wireless fidelity (Wi-Fi) direct (WFD) module, a WFD function of the WLAN module is switched from the disabled state to the enabled state in accordance with a connection state of the external device using a Bluetooth function, and the WPAN module performs the Bluetooth function to transmit connection information for the WFD function.

14. The image forming device of claim 12, wherein, when the WPAN module includes a near field communication (NFC) module and the WLAN module includes a WFD module, a WFD function of the WLAN module is switched from the disabled state to the enabled state in accordance with a connection of the external device using an NFC function, and the WPAN module performs the NFC function to transmit or receive connection information for the WFD function.

15. A method of controlling an image forming device, the method comprising:
determining a connection state of an external device using a wireless personal area network (WPAN) with the external device;
switching a wireless local area network (WLAN) module from a disabled state to an enabled state in accordance with the connection state of the external device using the WPAN;
receiving a request from the external device through the WLAN module; and
performing an image forming job based on the received request.
